(19) United States
(12) Patent Application Publication
(10) Pub. No.: US 2019/0002323 A1
(43) Pub. Date: Jan. 3, 2019

(54) TWO STAGE PYROLYSIS OF ORGANIC WASTE

(71) Applicant: ANAERGIA INC., Burlington (CA)

(72) Inventors: Andrew BENEDEK, Rancho Santa Fe, CA (US); Juan Carlos JOSSE, Aliso Viejo, CA (US)

(21) Appl. No.: 16/124,763

(22) Filed: Sep. 7, 2018

Related U.S. Application Data
(63) Continuation-in-part of application No. PCT/CA2017/050335, filed on Mar. 14, 2017.
(60) Provisional application No. 62/310,861, filed on Mar. 21, 2016.

(51) Int. Cl. C02F 11/10; C10K 1/06; C02F 11/12; F23G 5/027; C02F 11/04

(52) U.S. Cl. CPC C02F 11/10; C10K 1/06; C02F 11/04; F23G 5/027; C02F 11/12

(57) ABSTRACT

Organic waste is treated by pyrolysis or by anaerobic digestion followed by pyrolysis of the digestate. The pyrolysis is performed in two staged reactors. The second stage reactor treats char produced in the first stage. The temperature of the first stage reactor is preferably 450 degrees C. or less. The temperature of the second stage reactor is higher than the temperature of the first stage, for example by 50 degrees C. or more. Optionally, there may be a char cooler, a water sprayer, or both downstream of the char outlet of the second reactor. In an exemplary system, a digestate outlet is connected to the inlet of the first pyrolysis reactor. A pyrolysis liquid outlet of the first pyrolysis reactor is connected to the digester. Char produced in the second pyrolysis reactor may be used as a soil amendment.

### CROSS-REFERENCE TO RELATED APPLICATIONS

This application is a continuation-in-part of International Application Number PCT/CA2017/050335, filed on Mar. 14, 2017 and published as International Publication Number WO 2017/161445 A1 on Sep. 28, 2017, which claims the benefit of U.S. Provisional Application No. 62/310,861 filed on Mar. 21, 2016, all of which are incorporated herein by reference.

### FIELD

This specification relates to treating organic waste and pyrolysis.

### BACKGROUND

U.S. Pat. No. 8,877,468 describes a process in which materials containing lignocellulose are treated by pyrolysis under conditions (low temperature and long residence time) that favour the production of a liquid containing organic acids and alcohols. This liquid is suitable for conversion to biogas (primarily methane) in an anaerobic digester. U.S. Pat. No. 8,877,468 is incorporated herein by reference.

### INTRODUCTION

Organic waste can include, for example, the organic fraction of municipal waste, yard waste, industrial or commercial waste, agricultural waste or wastewater treatment primary or secondary sludge. Organic waste may be treated by pyrolysis or, optionally, by anaerobic digestion followed by pyrolysis of the digestate.

In a process described herein, pyrolysis is performed in two stages. The first stage treats a feedstock comprising organic waste to produce permanent gas, liquid (which may be condensed from vapor), and char. The second stage treats the char produced in the first stage. At least some of the first stage char (which may include oil in the pores of the first stage char) is converted into a permanent gas in the second stage, and some additional liquid (which may be condensed from vapor) may also be produced. The temperature of the first stage is preferably 450 degrees C. or less. The temperature of the second stage is higher than the temperature of the first stage, for example by 50 degrees C. or more. Optionally, one or more gasses produced in the first and/or second stages may be used to provide heat for pyrolysis or for drying feedstock. Optionally, one or more liquids produced in the first and/or second stage may be fed to an anaerobic digester. Optionally, an oily fraction may be separated from the one or more liquids before they are sent to the anaerobic digester.

An apparatus described herein has two pyrolysis reactors. A char outlet from the first reactor is connected to a feed inlet of the second reactor. Optionally, there may be a char cooler, a water sprayer, or both downstream of the char outlet of the second reactor. Optionally, the two pyrolysis reactors may be provided in the form of a two-stage pyrolysis reactor. The two stage pyrolysis reactor may use a common burner to heat both stages but to different temperatures.

A system described herein comprises a two-stage pyrolysis apparatus coupled to an anaerobic digester. A digestate outlet is connected to the inlet of a first pyrolysis reactor stage. A pyrolysis liquid outlet of the first pyrolysis reactor stage is connected to the digester. Optionally, an oil separator may be included between the pyrolysis liquid outlet and the digester.

In the apparatus, system and process described above, the first stage pyrolysis temperature favors the production of an aqueous liquid with dissolved compounds over the production of pyrolysis oil. The aqueous liquid is readily digested in an anaerobic digester, whereas pyrolysis oil is frequently toxic or at least inhibits growth of microorganisms in a digester. In some cases, the amount of pyrolysis oil is low enough to be included with the aqueous liquid sent to the anaerobic digester, in other cases the pyrolysis oil may be removed. However, the inventor has observed that pyrolysis under conditions that provide a large fraction of readily digestible liquid also produces oily char that is not very porous. Treatment of the char in a second stage of pyrolysis increases the quality of the char as a soil amendment. In at least some cases, the first stage char is converted in the second stage of pyrolysis from a waste product to a useful product. Optionally, non-condensed gasses produced in one or both stages may be used to provide heat for pyrolysis or for drying feedstock prior to pyrolysis.

### BRIEF DESCRIPTION OF THE FIGURES

FIG. 1 is a schematic drawing of an organic waste treatment system.

FIG. 2 is a schematic drawing of a two-stage pyrolysis reactor.

### DETAILED DESCRIPTION

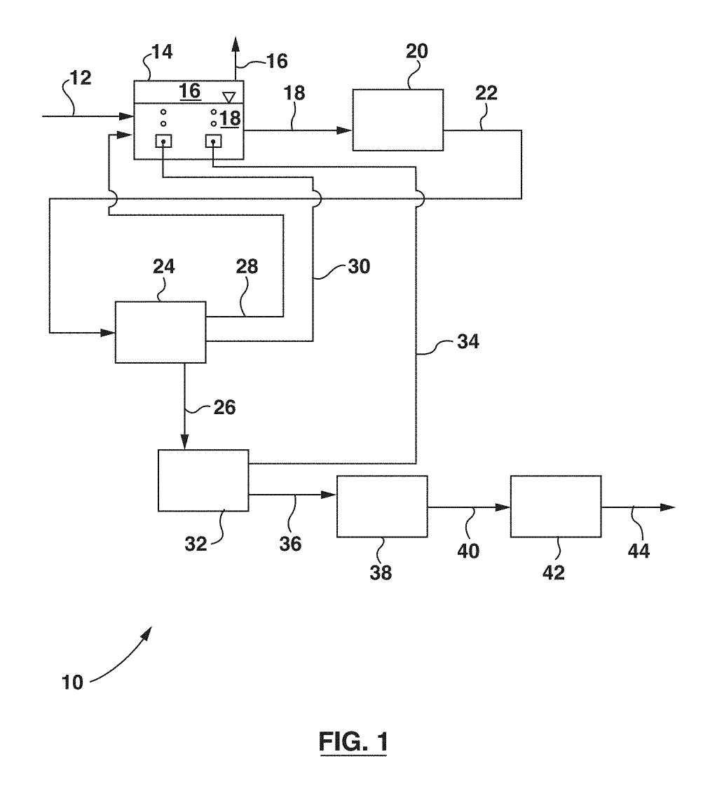

FIG. 1 shows a system 10 for treating organic waste 12. Optionally, the organic waste 12 may be pre-treated. For example, the organic waste 12 may have been separated from other waste, for example in a press or by a screen. Additionally or alternatively, solid particles of waste 12 may be homogenized or reduced in size.

The waste 12 is sent to an anaerobic digester 14, alternatively referred to as a digester for brevity. The digester 14 may have one or more mixed covered tanks. Examples of suitable digesters are sold under the Triton and Helios trade marks by UTS Biogas or Anaergia. The digester 14 produces product biogas 16 which may, for example, be used to produce energy in a combined heat and power unit or upgraded to produce biomethane. The inside of the digester contains sludge 18. A stream of sludge 18, alternatively called digestate, is also withdrawn from a digester outlet of the digester 14.

Sludge 18 is sent to a drying unit 20. In the drying unit 20, the sludge 18 is treated in a mechanical dewatering unit, for example a centrifuge, filter press or screw press. The mechanical dewatering unit separates the sludge 20 into a waste liquid, which may be sent to a sanitary drain or treated on site for discharge or re-use, and a de-watered cake. The de-watered cake is sent to a sludge cake dryer to further reduce its water content. Preferably, the de-watered cake is formed into digestate pellets, granules or flakes 22, depending on the type of dryer used. The pellets 22 may be transported, for example, by screw conveyors or in bags or bins.

Pellets 22 are sent to a first pyrolysis reactor 24. The first pyrolysis reactor 24 heats the pellets 22 in the absence or a deficiency of oxygen, to produce first biochar 26, pyrolysis liquid 28 and pyrolysis gas 30. The first pyrolysis reactor 24 produces an initial blended gas that passes through a condenser. In the condenser two streams are formed: pyrolysis liquid 28 and non-condensable or permanent gas 30. Pyrolysis liquid 28, which may include condensed vapors, is recycled to anaerobic digester 14 as additional feedstock for digestion. Optionally, the pyrolysis liquid 28 may be further separated into an aqueous fraction and an oily fraction with only the aqueous fraction sent to the anaerobic digester 14. The oily fraction may optionally be recycled to a pyrolysis reactor, optionally the second pyrolysis reactor 32 described further below, for conversion into pyrolysis liquid or pyrolysis gas, disposed of, used as fuel for example to provide heat for the sludge cake dryer or a pyrolysis reactor, or converted or refined into a liquid that is more readily digestible and sent to the anaerobic digester 14. Pyrolysis gas 30 is optionally also sent back to the digester 14. For example, the pyrolysis gas 30 may be injected into the bottom of the digester 14. Alternatively, the pyrolysis gas 30 may be burned to produce heat, for example in the sludge cake dryer or a pyrolysis reactor.

If it is sent to the anaerobic digester 14, the pyrolysis gas 30 is scrubbed to some extent as it rises in bubbles though sludge 18 in the digester 14. The pyrolysis gas 30 later mixes with biogas 16 in the headspace of the digester 14 to increase its heat value. Part of the pyrolysis gas 30, particularly the hydrogen, may also be transferred into the sludge 18 and be biologically converted to methane. The transfer of pyrolysis gas 30 to sludge 18 in the digester 14 can optionally be enhanced by injecting the pyrolysis gas 62 as fine bubbles, by adding the pyrolysis gas through a dissolution cone into a stream of recirculating sludge, or by recirculating the headspace gas. Optionally, if the recycle of pyrolysis gas 30 increases the concentration of carbon monoxide (CO) in the biogas 16 too much, CO can be removed from the pyrolysis gas 30 or biogas 16 by membrane separation, or the pyrolysis gas 30 can be at least partially converted to methane before being added to the digester 14.

The temperature in the first pyrolysis reactor 24 may be over 270 degrees C., optionally over 300 degrees C., optionally over 320 degrees C. The temperature in the first pyrolysis reactor 24 may be less than 450 degrees C., optionally less than 400 degrees C. and optionally less than 350 degrees C. The residence time may be 5-30 minutes, optionally 10-20 minutes. Pyrolysis of organic, for example cellulosic, material at over 450 degrees C. produces an excess of oils that may be toxic to microorganisms in an anaerobic digester. Pyrolysis at lower temperatures produces less of the toxic substances and also produces more pyrolysis liquid 28 relative to pyrolysis gas 30. This is beneficial since the pyrolysis liquid 28 is easily mixed into sludge 18 in the anaerobic digester 14 and enhances production of biogas 16. However, at very low temperatures the production of biochar 26 dominates. A temperature of 320 to 350 degrees and residence time of about 10-20 minutes may be useful for producing a large fraction of pyrolysis liquid 28 that is digestible, optionally after removal of an oily fraction from it.

The first biochar 26 is conveyed, for example dropped, into a second pyrolysis reactor 32. Optionally, the first pyrolysis reactor 24 and the second pyrolysis reactor 32, or parts of them, may be combined into an integrated device for example a two stage reactor. The first biochar 26 is preferably not cooled before second stage pyrolysis. Second pyrolysis reactor 32 operates at a higher temperature. Temperature in the second pyrolysis reactor 32 may be 50 degree C. or more higher than the temperature in the first pyrolysis reactor 24. The temperature in the second pyrolysis reactor 32 may be over 400 degrees C., optionally over 450 degrees C., optionally over 600 degrees C. The temperature in the second pyrolysis reactor 32 may be 900 degrees C. or less, 550 degrees C. or less, or 500 degrees C. or less. In some examples, the temperature in the second pyrolysis reactor 32 may be in the range of 600 to 800 degrees C. or in the range of 650 to 750 degrees C. The residence time may be 5-45 minutes, optionally 5-30 minutes, or optionally 10-20 minutes. For example, the second pyrolysis reactor 32 may treat the first char 26 at 450-500 degrees C. for 10-20 minutes. In another example, the second pyrolysis reactor 32 may treat the first char 26 at 600-800 degrees C. for 5-45 minutes.

The second pyrolysis reactor 32 produces second pyrolysis gas 34. Second pyrolysis gas 34 may be returned to digester 14 or used to provide heat as described for the pyrolysis gas 30. The second pyrolysis reactor 32 might also produce a small amount of liquid. If so, this pyrolysis liquid tends to contain oils that are toxic to the microorganisms in the digester 14. The second pyrolysis liquid can be recycled through a pyrolysis reactor such as the second pyrolysis reactor 32 until it is converted into gas, disposed of, sold for use as pyrolysis oil, burned to produce heat or converted or refined into a liquid that can be sent to the digester 14.

The second pyrolysis reactor 32 also produces second char 36. Second char 36 passes through a cooler 38 to produce cooled char 40. The cooler 38 may be, for example, a jacketed screw cooler with cool water flowing through a hollow screw to provide indirect cooling. Cooled char 40 passes under a water sprayer 42 to produce stabilized char 44. If not sprayed, the cooled char 40 absorbs water from the air and re-heats. The amount of water required to stabilize the char (i.e. reduce its tendency to re-heat) appears to be related to the relative humidity of the ambient air. Second char 36, or preferably cooled char 40 or stabilized char 44, may be used as a soil enhancer.

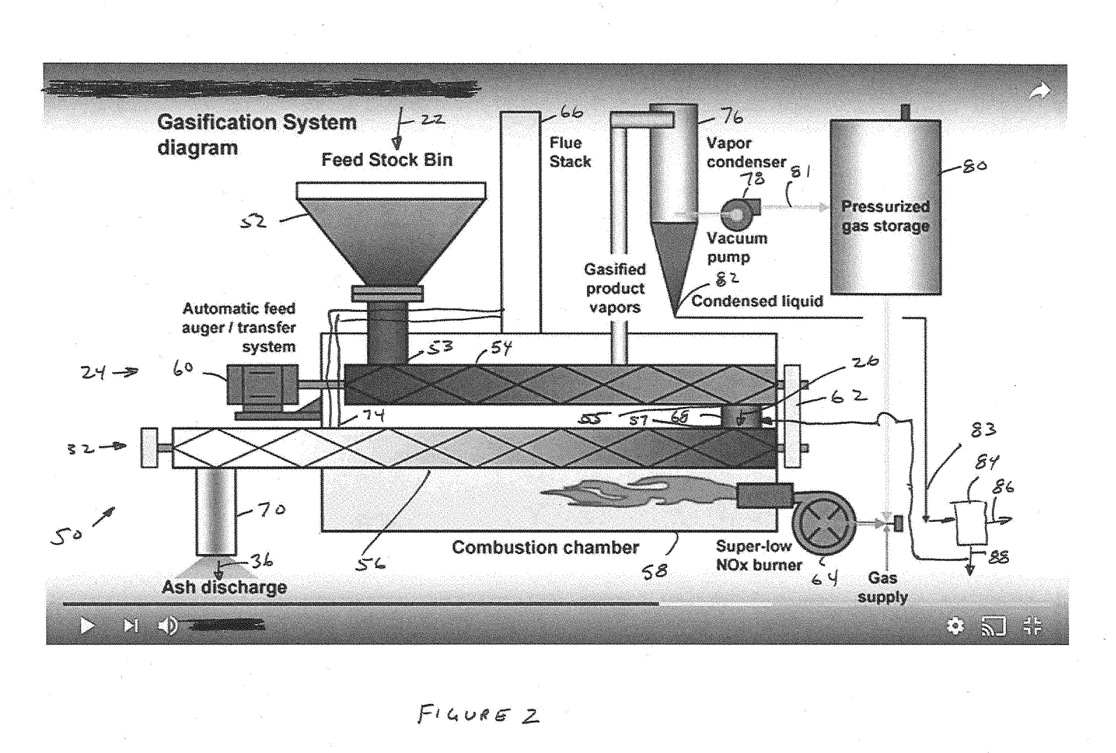

FIG. 2 shows an example of a two-stage pyrolysis reactor 50 that may be used to provide the first pyrolysis reactor 24 and the second pyrolysis reactor 32 in an integrated unit. The first pyrolysis reactor 24 is provided by a first conveyor 54 inside of a combustion chamber 58. The second pyrolysis reactor is provided by a second conveyor 56 inside the same combustion chamber 58. The conveyors 54, 56 may be, for example, screw conveyors. In the example shown, the conveyors 54, 56 are driven by a shared motor 60 and transmission 62. Optionally, the transmission 62 causes the second conveyor 56 to move more slowly than the first conveyor 54 such that the second pyrolysis reactor 32 has a higher residence time than the first pyrolysis reactor 24. A burner 64 of the combustion chamber 58 is located to produce heat, for example as provided by flames, closer to the second conveyor 64 than the first conveyor 62 such that the second pyrolysis reactor 32 has a higher temperature than the first pyrolysis reactor 24. Burnt products of combustion are collected in a flue stack 66 of the combustion chamber 58 and may be treated before being released to the atmosphere.

Digestate or other feedstock, for example pellets 22, is fed to a feed stock bin 52 or hopper of the two-stage pyrolysis reactor 50. The feed stock bin 52 is connected to an inlet 53 of the first pyrolysis reactor 24 in communication with the first conveyor 54. The pellets 22 travel through the first conveyor 54 and are converted, among other things, into first char 26. A char outlet 53 of the first pyrolysis reactor 24 connects the first conveyor 54 through a chute 68 to an inlet 57 of the second pyrolysis reactor 32 which is in communication with the second conveyor 56. First char 26 passes through the chute 68 and is converted in the second pyrolysis reactor 32 into second char 36, among other things. Second char 36 is collected at a char outlet 70 of the second pyrolysis reactor 32 which is in communication with the second conveyor 56. Char outlet 70 is optionally connected to a cooler 38 and water sprayer 42 as discussed above.

The first pyrolysis reactor 24 has a gasified products outlet 72 in communication with the first conveyor 54. Gasses, including vapors, produced in the first pyrolysis reactor 24 flow to a vapor condenser 76. Permanent gasses 81 are removed by vacuum pump 78 and stored in a gas storage vessel 80. The gas storage vessel 80 can be connected to the burner 64 and/or a sludge cake dryer of drying unit 20. In this case, the permanent gasses are burned to provide heat for pyrolysis or drying. Condensed liquids 83 are collected from an outlet 82 of the condenser and optionally flow directly to the digester 14. Alternatively, the condensed liquids 83 flow to a separator 84 which produces an aqueous fraction 86 and an oily fraction 88. The separator 84 may be, for example, another stage of a two stage condenser including the vapor condenser 76, a decanting device or a centrifugal separator. The aqueous fraction 86 is sent to the digester 14. The oily fraction 88 may be sent to the second pyrolysis reactor 32 to be converted into permanent gas, disposed of, sold as a bio-oil for example for heating or a vehicle fuel, or refined or treated to remove inhibitory compounds and then sent to the digester 14.

The second pyrolysis reactor 32 has a gasified products outlet 74 in communication with the second conveyor 56. The gasified products outlet 74 of the second pyrolysis reactor 32 is optionally connected to the gasified products outlet 72 of the first pyrolysis reactor 24 as in the example shown. In this case, gasses, including any vapors, in produced in the second pyrolysis reactor 32 are treated and used as described for the first pyrolysis reactor 24. Optionally, particularly if the temperature in the second pyrolysis reactor 32 is high, for example 600 degrees C. or more, the gasified products outlet 74 of second pyrolysis reactor 32 may be connected directly to burner 64 and/or a sludge cake dryer of drying unit 20. Alternatively permanent gasses produced in the first pyrolysis reactor 24 and/or the second pyrolysis reactor 32 may be sent to the digester 14 as discussed above.

In an example, primary and secondary sludge from a wastewater treatment plant was fed to an anaerobic digester 14. The digestate 18 was dried (92% solids) and pelletized and sent to a first pyrolysis reactor 24. The mass of first char 26 was 55% of the mass of pellets 22 on a dried solids basis. Thus the first pyrolysis reactor 24 reduced the volume of sludge 18 solids for disposal by 45%. However, the first char 26 was not acceptable for use a soil amendment. Its porosity and adsorption were low, possibly because there was pyrolysis oil in the pores of the first char 26. The first char 26 smelled like oil.

The first char 26 emerged from the first pyrolysis reactor 24 as a charcoal-like pellet that could be conveyed to a second pyrolysis reactor 32 while still hot, along with some ash. The first char 26 was re-pyrolyzed in a second pyrolysis reactor at 450 degrees C. The second char 36 was reduced in mass (relative to first char 26) by another 5-10% of the dried solids mass of pellets 22. Second char 36 was cooled and sprayed with water to 96% solids. The second char 36 was porous and high in nitrogen and phosphorous (11%). The second char 36 was suitable for use as a soil amendment.

We claim:

1. A process for treating organic waste comprising steps of,
pyrolysing the organic waste in a first stage and producing at least a first char; and,
pyrolysing the first char in a second stage and producing a second char.

2. The process of claim 1 wherein the temperature in the second stage is higher than the temperature of the first stage by 50 degrees C. or more.

3. The process of claim 1 wherein the temperature of the first stage is 450 degrees C. or less

4. The process of claim 1 wherein the first stage produces a liquid and the further comprises treating at least a portion of the liquid in an anaerobic digester.

5. The process of claim 4 further comprising separating an oily fraction from the liquid.

6. The process of claim 5 further comprising burning or pyrolysing the oily fraction.

7. The process of claim 1 wherein the organic waste comprises digestate.

8. The process of claim 1 further comprising cooling the second char.

9. The process of claim 1 further comprising spraying water on the second char.

10. The process of claim 1 further comprising adding gas produced in the first stage or the second stage or both to sludge in an anaerobic digester or burning the gas to produce heat for pyrolysis or drying digestate.

11. The process of any claim 1 wherein the first stage pyrolysis is conducted at a residence time of 5 to 30 minutes.

12. A pyrolysis apparatus comprising,
a first pyrolysis reactor having an inlet and a first outlet; and,
a second pyrolysis reactor having an inlet and a first outlet,
wherein the first outlet from the first pyrolysis reactor is connected to the inlet of the second pyrolysis reactor.

13. The apparatus of claim 12 further comprising a char cooler downstream of the first outlet of the second pyrolysis reactor.

14. The apparatus of claim 12 having a water sprayer downstream of the first outlet of the second pyrolysis reactor.

15. The apparatus of claim 12 further comprising an anaerobic digester.

16. The apparatus of claim 15 wherein a digestate outlet of the anaerobic digester is connected to the inlet of the first pyrolysis reactor.

17. The apparatus of claim 15 wherein a second outlet of the first pyrolysis reactor is connected to the digester.

18. The apparatus of claim 17 having an oily fraction separator in communication with the second outlet of the first pyrolysis reactor.

19. The apparatus of claim 12 wherein the first pyrolysis reactor and the second pyrolysis reactor share a common combustion chamber.

20. The apparatus of claim 19 wherein the second pyrolysis reactor is located closer to a burner in the combustion chamber.
